(19) United States
(12) Patent Application Publication
(10) Pub. No.: US 2003/0206694 A1
(43) Pub. Date: Nov. 6, 2003

(54) Photonic multi-bandgap lightwave device and methods for manufacturing thereof

(75) Inventors: Sergey Babin, Castro Valley, CA (US); Alexander Goltsov, Paramus, NJ (US); Vladimir Goloviznine, Nieuwegein (NL); Anatoli Morozov, Hightstown, NJ (US); Natalya Polonskaya, Westwood, NJ (US); Vladimir Yankov, Washington Twp., NJ (US); Igor Ivonin, Uppsala (SE); Michael Spector, Hackensack, NJ (US); Andrei Talapov, Tenafly, NJ (US); Leonid Polonskiy, Westwood, NJ (US); Robert Paul Dahlgren, San Jose, CA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Vyoptics, Inc., Allendale, NJ

(21) Appl. No.: 10/137,152

(22) Filed: May 2, 2002

(51) Int. Cl. G02B 6/26; G02B 6/28

(52) U.S. Cl. 385/31; 385/15; 385/27; 385/39; 385/24

(57) ABSTRACT

The present invention provides a photonic multi-bandgap structure, herein also referred to as photonic bandgap quasi-crystal (“PBQC”), that can direct light, having wavelength components within a selected passband (Δλ), from an input port, to a predefined output port, while providing an integrating element for Planar Lightwave Circuts. A photonic bandgap quasi-crystal of the invention combines in a planar waveguide spectrally selective properties of gratings, focusing properties of elliptical mirrors, superposition properties of thick holograms, photonic bandgaps of periodic structures, and flexibility of binary lithography. A photonic structure of the invention can be utilized, for example, as an integrating spectrally sensitive element in a variety of optical devices that can include, but are not limited to, optical switches, optical multiplexer/demultiplexers, multi-wavelength lasers, and channel monitors in Wavelength Division Multiplexing (WDM) telecommunications system.

### FIELD OF THE INVENTION

The present invention generally relates to optical communications and optical transmission systems. In particular, the present invention provides an optical integrator utilizing a photonic bandgap quasi-crystal architecture to connect optical devices within a single monolithic lightwave integrated circuit.

### BACKGROUND OF THE INVENTION

The present invention relates generally to optical devices for fiber communication, and more particularly, to optical devices that include photonic structures for spectrally selective connection of optical components.

The rapid rise in demand for high-capacity and efficient optical telecommunication in the past several years has created the need for enhanced wideband communications systems. Increasing the bandwidth of a telecommunications system by routing additional fiber optic cables, although feasible, is typically very expensive. An alternative cost-effective solution is to transmit multiple messages from a large number of information sources in one location to a large number of receivers in another location by utilizing multiple light wavelengths. Each individual stream of information, which emanates from a single information source, is typically denoted as a connection. In such a multi-connection communications system, connections associated with several information sources are combined (multiplexed), and transmitted as a composite signal over a single transmission line. At the receiver, the individual connections are separated (demultiplexed). Since each connection is assigned a pre-defined wavelength, such a communications method is generally known as wavelength division multiplexing (WDM). Although optical and/or opto-electronic components are generally needed to perform multiplexing and demultiplexing tasks, one important advantage of multiplexing communications systems is a reduction in the number of transmission lines for a given bandwidth, which can substantially reduce infrastructure costs.

A variety of optical and opto-electronic devices, such as, multiplexers, integrating elements, switches, lasers, modulators, photodiodes, optical isolators, circulators, and receivers are employed in wavelength division multiplexing systems. An integration of such optical and opto-electronic devices in the same monolithic lightwave circuit can improve the performance of WDM systems while simultaneously reducing manufacturing cost. Lithographic fabrication techniques, and planar lightwave circuits (PLC) are currently utilized, inter alia, for generating such integrated platforms. Conventional PLCs can, however, present a number of shortcomings. For example, optical elements of a conventional PLC are typically interconnected by utilizing ridge (rib) waveguides, which are analogs of wiring in electronic integrated circuits (K. Okamoto, Fundamentals of Optical Waveguides, Academic Press, 2000). Such ridge waveguides limit the possibility of two-dimensional light propagation. In fact, in ridge waveguides, light propagates in one dimension, e.g., forward and backward along the waveguide axis. Also, the ridge waveguides cannot intersect each other.

Arrayed Waveguide Grating (AWG) multiplexers and integrating elements present typical examples of PLCs having ridge waveguides. While AWG's do not demand the option for the ridge waveguides to cross in one plane, more complex integrated devices may require such crossings.

Photonic bandgap crystals have recently emerged as potential competitors for replacing ridge waveguides as connecting elements. (J. D. Joannoupoulos, R. Meade, and J. Winn. Photonic Crystals (Princeton U. Press, Princeton, N.J., 1995)). Photonic bandgap crystals use a planar periodic structure to create a range of wavelengths at which light cannot propagate through a planar waveguide and range of wavelengths (passbands) that are readily propagated. One disadvantage of photonic crystals is that the strong variation of refraction index necessary for wavelength differentiation in two directions leads to light scattering in a third direction. Another problem is crosstalk between connections at different wavelengths that the crystal allows to propagate.

Gratings can also be utilized to connect optical devices. For example, U.S. Pat. No. 4,923,271 issued on May 8, 1990 describes an optical MUX/DEMUX comprising cascaded elliptic Bragg reflectors (gratings). These gratings are formed in a planar waveguide by employing microlithography. Each grating is tuned to a definite light wavelength corresponding to one of the working channels. The gratings have one common focal point and different ellipticities such that the location of the remaining focus may be chosen so as to provide adequate spacing between the input and output ports.

However, the device described in U.S. Pat. No. 4,923,271 is not scalable to a high number of connections. The gratings are spatially separated for sequential processing of light in each of them. As the number of channels, and the number of corresponding of wavelengths to be processed grow, the size of the device will increase, the path of light to the remote gratings, and consequently intrinsic losses, will grow. Further, manufacturing large devices is difficult and expensive due to limited precision of the lithographic process and uniformity of the planar waveguide used as a substrate for the gratings.

An example of integrated optical device is an Add/Drop Multiplexers (OADM) described by P. Kersten, F. Bakhti in Proceedings of SPIE, Vol. 4277 2001, Page 54, San Jose, USA. OADM usually includes an AWG as a demultiplexer, a thermooptical switching matrix, and an AWG multiplexer. Double passing of light through AWGs results in strong loss of about 3-10 dB.

Another example of an integrated optical device is a channel monitor required for dynamic control of the signals propagating in different channels of multichannel systems. Placing multiplexer/channel monitors/attenuators/demultiplexer on a single planar structure represents significant problems because of the need for multiple intersections of light connections.

Thus, there is a need for enhanced optical devices, such as, switches, multi-wavelength lasers, channel monitors, modulators, multiplexers/demultiplexers, that can be readily incorporated in integrated optical and opto-electronic devices for use in wavelength division multiplexing systems.

Further, there exists a need for integrating elements for planar lightwave circuits that allow a flexible planar layout of light beams such that the beams can cross one another in a plane and provide spectrally-sensitive connection of optical devices.

### SUMMARY OF THE INVENTION

A photonic multi-bandgap structure of the present invention, herein also referred to as photonic bandgap quasi-crystal (“PBQC”), can direct light, having wavelength components within a selected passband (Δλ), from an input port, to a predefined output port, while providing interconnecting and integrating element for Planar Lightwave Circuits. Photonic bandgap quasi-crystals can combine the spectrally selective properties of gratings, the focusing properties of elliptical mirrors, the superposition properties of thick holograms, the photonic bandgaps of periodic structures, and the flexibility of binary lithography on planar waveguides. In other words, a photonic bandgap quasi-crystal is a quasi-periodic structure with multiple periods and multiple, elliptically-shaped bandgaps. These photonic bandgap quasi-crystals can be made on planar waveguides from sub-wavelength features, herein referred to as “dashes”, with binary lithography. A dash can be, for example, an etched line segment having selected depth, width and length. A single photonic bandgap quasi-crystal provides many connections with different desirable transfer functions.

In one aspect, the present invention provides an optical device that includes an optical waveguide and a photonic multi-band gap structure optically formed therein. The waveguide includes one or more input ports and a plurality of output ports, and allows transmission of light, having one or more wavelength components within a selected wavelength range, between these ports. The photonic multi-band gap structure directs light having wavelength components in each passband region (Δλ), within the wavelength range that is transmissible through the waveguide, from pre-selected input ports to pre-selected output ports.

In another aspect, the photonic multi-band gap structure is formed of a plurality of reflective micro-elements disposed on a planar surface of the waveguide so as to form a quasi-periodic pattern. Each micro-reflective element provides a local modulation of the index of refraction of the planar surface on which it is disposed, and the micro-reflective elements collectively reflect light having wavelength components within a plurality of passband regions (Δλᵢ, i=1, . . . n) such that the reflections corresponding to each passband region Δλᵢ interfere on average constructively in a selected direction, for example, a direction associated with an output port of the optical device.

In a related aspect, the micro-reflective elements are disposed on a surface (x,y) of the waveguide at locations corresponding substantially to local maxima of a generating function A(x,y), representing a two-dimensional profile of refraction index as a linear superposition of a plurality of modulation functions each describing a separate sub-grating.

In one embodiment, the generating function A(x,y) is defined in accord with the relation:

$$A ( x , y ) ∼ {\sum }_{i = 1}^{i = N} {a}_{i} Sin ( 2 π ( 1 + f ( x , y ) ) l / {λ}_{i} + {ϕ}_{i} ) ,$$

wherein

i is an index that refers to a connection made between a selected input port and a selected output port,

$${l}_{i} = \vert {\vec{r}}_{i}^{in} \vert + \vert {\vec{r}}_{i}^{out} \vert ,$$

wherein

$${\vec{r}}_{i}^{in}$$

is a vector connecting the input port i to an arbitrary point (x,y) on the planar surface,

$${\vec{r}}_{i}^{out}$$

is a vector that connects this point (x,y) with the output port i for a chosen wavelength λᵢ,

αᵢ is a weight coefficient associated with the connection i,

φᵢ is an arbitrary phase associated with the connection number i,

and ƒ(x,y) is a function that compensates for variation of refractive index, as discussed in more detail below.

In a related aspect, the binary function B(x,y) can be defined in accord with the relation:

B(x,y)=1, if A(x,y)>0 and

B(x,y)=0 otherwise.

In another aspect, in an optical device of the invention as described above, the micro-reflective elements are disposed on a surface of the waveguide in accord with a pattern defined by a function, herein referred to as C(x,y), that approximates the function B(x,y) as a plurality of discrete elements having pre-defined shapes and positions. The discrete elements can be, for example, “dashes” having pre-defined widths, depths and lengths.

In a related aspect, the micro-reflective elements provide quasi-periodic modulation of index of refraction of a surface of the waveguide. The micro-reflective elements can be, for example, any of a ridge, a groove, or a micro-location doped with a selected ion in a surface of the waveguide.

In further aspects, an optical device of the invention includes a substrate on which an optical waveguide is disposed as a stack of alternating low refractive index cladding and high refractive index core layers. A ratio of the index of refraction of core layer relative to that of cladding layer can be, for example, in a range of about 1.2 to about 2. The optical waveguide can be configured to be substantially transparent to radiation having wavelength components in a range of about 800 nm to about 1600 nm, and can also be configured for transmission of light having any of a TM or TE polarization modes. A photonic structure of the invention, as described above, can be formed in the waveguide for selectively directing wavelength components from an incident direction to a pre-defined output direction.

In other aspects, the invention provides an integrated multi-wavelength laser/optical modulator for use in a WDM system that includes a multi-wavelength laser, a plurality of modulators, and a multiplexer formed in a planar waveguide. The laser can include a lasing medium and a broadband mirror that is optically coupled thereto. A photonic multi-band gap structure optically coupled to the lasing medium focuses each wavelength component of light emitted from the lasing medium to one of a plurality of pre-defined locations in the waveguide. The term “wavelength component” as used herein can refer to a specific wavelength λ, or alternatively a wavelength range (Δλ) spanned around the specific wavelength λ. The wavelength range (Δλ) is also herein referred to as a passband region. The integrated multi-wavelength laser/optical modulator further includes a plurality of mirrors, each of which is positioned at proximity of one of the pre-defined locations corresponding to a wavelength component at which said each mirror is at least partially reflective. Each wavelength sensitive mirror, together with the photonic structure, the lasing medium, and the broadband mirror, forms a lasing cavity for a particular wavelength, i.e., the wavelength at which the wavelength sensitive mirror is at least partially reflective.

In a related aspect, in an integrated multi-wavelength laser/optical modulator as described above, each partially reflective mirror allows transmission of a selected portion of light to generate an output signal, e.g., a laser signal, at a selected wavelength. A plurality of modulators, each of which receives an output signal associated with one of the partially reflective mirrors, modulates the output signals, and a multiplexer formed according to the teachings of the invention receives the modulated signals at a plurality of input ports and direct the signals to an output port.

In another aspect, the present invention provides a channel monitor and control device for use in a WDM system that includes a demultiplexer, formed in a planar waveguide, that employs a photonic multi-band gap structure for directing each wavelength component of an input light signal to a pre-defined location in the waveguide. The device includes additional photonic multi-bandgap structures according to the teachings of the invention, each of which is positioned at proximity of one of the pre-defined locations to receive a selected wavelength component of input light reflected by the demultiplexer. Each of these additional photonic structures transmits a portion of the received light, and reflects a smaller portion of the received light to a pre-defined location in the waveguide. The device further includes a plurality of detectors each positioned to detect light reflected from one of said photonic multi bandgap structures and to generate an output signal in response to the detected light. A control circuit is electrically coupled to the detectors to receive the electrical signals, and to generate a plurality of control signals to be applied to a plurality of attenuators, each of which is optically coupled to one of the photonic multi-bandgap structures to receive the light transmitted by that structure. Each control signal sets the attenuation level of a corresponding attenuator.

Further understanding of the invention can be obtained by reference to the following detailed description and associated drawings which are described briefly below.

### BRIEF DESCRIPTION OF THE DRAWINGS

FIG. 1 schematically depicts the functionality of an optical device of the invention,

FIG. 2 shows an optical device according to the teachings of the invention, fabricated on a planar optical waveguide,

FIG. 3 is an exemplary depiction of a two-dimensional generating function A(x,y) utilized in the first step of a method of the invention for generating a photonic multi-gap structure according to the invention,

FIG. 4 is an exemplary depiction of a binary function B(x,y) that approximates the generating function A(x,y),

FIG. 5 is an exemplary depiction of a plurality of discrete elements disposed on a surface in accord with a pattern defined by a function C(x,y) generated in a method of the invention as a discretized approximation of the binary function (x,y),

FIG. 6 shows the discrete elements of FIG. 5 with selected ones of the discrete elements removed,

FIG. 7 is a schematic exemplary diagram of dispersion characteristics of a photonic structure of the invention that is characterized by the presence of a multiplicity of bandgaps,

FIG. 8 shows exemplary experimental data obtained from a proto-type of an optical device according to the teachings of the invention,

FIG. 9 shows an exemplary channel monitor and control device formed according to the teachings of the invention for use in a WDM system,

FIG. 10 illustrates another embodiment of the device of FIG. 9, and

FIG. 11 illustrates an integrated multi-wavelength laser/modulator for use in a WDM system formed in accordance with the teachings of the invention.

### DETAILED DESCRIPTION

The present invention provides a photonic multi-bandgap structure, herein also referred to as photonic bandgap quasi-crystal (“PBQC”), that can direct light, having wavelength components within a selected passband (Δλ), from an input port, to a predefined output port, while providing an integrating element for Planar Lightwave Circuits. A photonic bandgap quasi-crystal of the invention combines in a planar waveguide spectrally selective properties of gratings, focusing properties of elliptical mirrors, superposition properties of thick holograms, photonic bandgaps of periodic structures, and flexibility of binary lithography. A photonic structure of the invention can be utilized, for example, as an integrated spectrally sensitive element in a variety of optical devices that can include, but are not limited to, optical switches, optical multiplexer/demultiplexers, multi-wavelength lasers, and channel monitors in Wavelength Division Mulitplexing (WDM) telecommunications system.

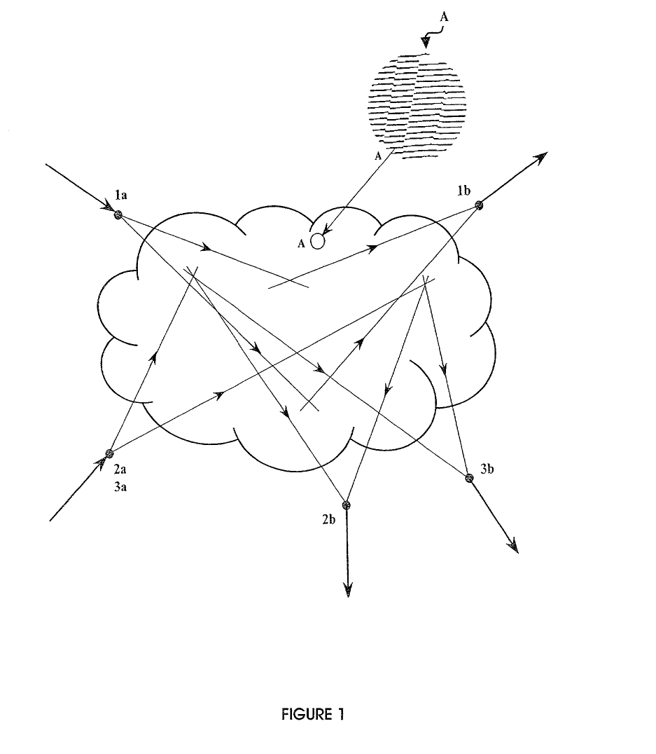

FIG. 1 illustrates schematically the general functionality of optical devices that can be formed according to the teachings of the invention. In particular, such optical devices can include mirco-reflective elements A positioned on a surface in accord with the teachings of the invention, as described in detail below, to form a quasi-periodic pattern to allow selectively directing an input signal, such as signals 1a, 2a, and 3a, received via an input port to a pre-defined output port based on the wavelength, or more generally passband (Δλ), of the input signal, to form an output signal, such as signals 1b, 2b, and 3b corresponding to the input signals 1a, 2a, and 3a, respectively.

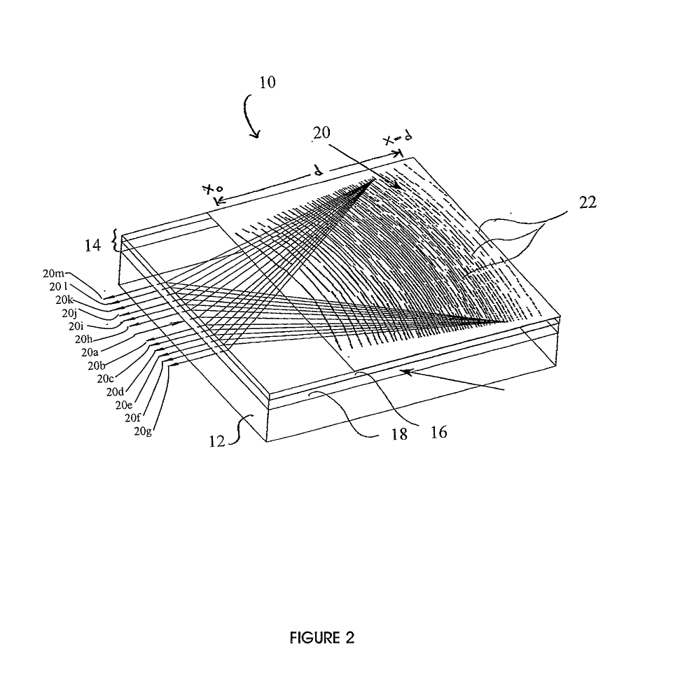

FIG. 2 shows an exemplary optical device 10 according to the teachings of the invention that includes a substrate 12 on which a planar waveguide 14 is disposed. The waveguide 14 is preferably substantially transparent to light having one or more wavelength components in a selected wavelength range, e.g., about 800 nm to about 1600 nm, and comprises at least two layers: a lower cladding and a core. It can also include an upper cladding layer. In addition, the core can include several layers. The core refractive index is preferably greater than the indices of both cladding layers, resulting in confinement of light by cladding layers and guiding it along the core.

The exemplary waveguide 14 is formed of a core 16 and a cladding 18, and further includes a plurality of optical ports 20a, 20b, 20c, 20d, 20e, 20f, 20g, 20h, 20i, 20j, 20k, 201, and 20m, herein collectively referred to as optical ports 20, that allow coupling light to the waveguide layer. Although this exemplary waveguide 14 includes one cladding layer, namely, the layer 18, other waveguides suitable for use in the optical device 10 can include another cladding layer disposed over the core layer 16, or a plurality of alternating cladding and core layers.

In this exemplary embodiment, the port 20a functions as an input port for coupling radiation into the waveguide 14 and the ports 20b-20m function as output ports for transmitting radiation from the waveguide 14 to the outside environment, for example, to other optical or optoelectronic components of a device in which the optical device 10 is incorporated. Those having ordinary skill in the art will appreciate that this distinction between the port 20a and the ports 20b-20m is arbitrary and any of these ports can be configured as an input port or an output port. Further, the number of ports in a device of the invention can be more or less than that shown in this exemplary embodiment.

The optical device 10 further includes a photonic multi-bandgap structure 20 according to the teachings of the invention, which is formed of a plurality of reflective micro-elements 22 in a manner described in more detail below. The exemplary photonic structure 20 is formed on a planar surface of the optical waveguide 14, for example, at an interface of the cladding 18 with the core 16. It can also be formed at other interfaces inside or outside of the waveguide, provided that the light mode propagating through the waveguide has a significant amplitude at the location where the described photonic structure is formed. In general, the photonic structure 20 is formed in such a way so as to optimize optical coupling of light traveling through the waveguide 14 thereto.

The photonic structure 20 directs light having wavelength components within a selected passband region (Δλ), which is encompassed within the wavelength range in which the waveguide is substantially transparent, from a selected one or more of the ports 20a-20m to other pre-defined one or more of these ports. For example, the photonic structure 20 can be designed to transmit light within one passband region Δλ₁ from the input port 20a to the output port 20c, and to transmit light within another passband region Δλ₂ from the input port 20a to another output port 20h.

With continued reference to FIG. 2, the exemplary micro-reflective elements 22 form a quasi-periodic pattern, herein referred to as “quasi-crystal”, such that the photonic multi-bandgap structure exhibits a dispersion function characterized by a plurality of bandgaps. Each bandgap effects reflection of light, having wavelength components within a selected passband region, and incident on the photonic structure along a selected input direction, to an output direction that forms a pre-defined angle relative to the input direction. In other words, the photonic structure 20 can form an optical connection between two points, for example, an input point and an output point, such that any wavelength component within a selected passband region is transmitted from the input point to the corresponding output point. The transfer function of each optical connection can be individually tailored.

As discussed above, the micro-reflective elements 20 form a pre-determined planar quasi-periodic pattern of sub-wavelength features. Positions of features are carefully chosen to optimize transfer functions of all connections. In a method of the invention for generating a quasi-periodic pattern, in an initial step, a generating function A(x,y), which resembles a superposition of a plurality of interference fringes of pairs of diverging and converging light beams, is defined in accord with the relation:

$$A ( x , y ) ∼ {\sum }_{i = 1}^{i = N} {a}_{i} Sin ( 2 π ( 1 + f ( x , y ) ) {l}_{i} / {λ}_{i} + {ϕ}_{i} ) , \qquad Eq . ( 1 )$$

wherein the index i refers to a connection made between a selected input port and a selected output port,

$${l}_{i} = \vert {\vec{r}}_{i}^{in} \vert + \vert {\vec{r}}_{i}^{out} \vert ,$$

wherein

$${\vec{r}}_{i}^{in}$$

is a vector connecting the input port i to an arbitrary point (x,y) on the planar surface,

$${\vec{r}}_{i}^{out}$$

is a vector that connects this point (x,y) with the output port i for a chosen wavelength λᵢ, αᵢ is a weight coefficient associated with the connection i, and φᵢ is an arbitrary phase associated with the connection number i, and ƒ(x,y) is a function that compensates for variation of refractive index, as discussed in more detail below.

The coefficient aᵢ can be determined, for example, by simulation or experimentally, so as to obtain a desired transfer function for each optical connection. For example, all channels are polled to define αᵢ value so as to obtain constructive interference for as many channels as possible.

Each term in the summation defining the function A(x,y) corresponds to a distinct sub-grating. That is, each term by itself provides a set of elliptical grating lines that can function as a Bragg reflector at a particular wavelength. The summation superimposes these sub-gratings such that constructive reflections can occur for light having wavelength components within a plurality of passband regions, as discussed in more detail below.

As mentioned above, the function ƒ(x,y) is utilized in the above Equation (1) to compensate for variation of average effective refraction index. In the first approximation, the function ƒ(x,y) can be selected to be identically zero for all values of x and y. That is, the above Equation (1) can be utilized without any compensation for variation of the average effective refraction index. However, the variations in the refraction index of those regions of the waveguide 14 in which the photonic structure 20 is disposed can lead to undesirable distortions. Thus, in more preferred embodiments of the invention, the function ƒ(x,y) is defined in accord with the following relation:

ƒ(r)=1+Δn/n Eq. (2)

wherein r=\sqrt{x²+y²}, and Δn represents an average variation of the effective index of refraction in the vicinity of a point (x,y). It is a natural assumption that Δn/n can be linearly proportional to an apodizing function. An example of an apodizing function is discussed in more detail below.

If index of refraction of of a planar waveguide, such as, the above waveguide 14, can be modulated in accordance with the above generating function A(x,y), each subgrating, can create constructive interference for an optical connection formed between corresponding input and output ports at pre-selected wavelengths. A set of points for each connection i that provide the same phase for the sine function in the above equation, that is, those points that satisfy the following constraint:

lᵢ[1+ƒ(x, y)]=const Eq. (3)

lie on a circumference of an ellipse whose two foci can correspond, for example, to an input port and an output port, respectively.

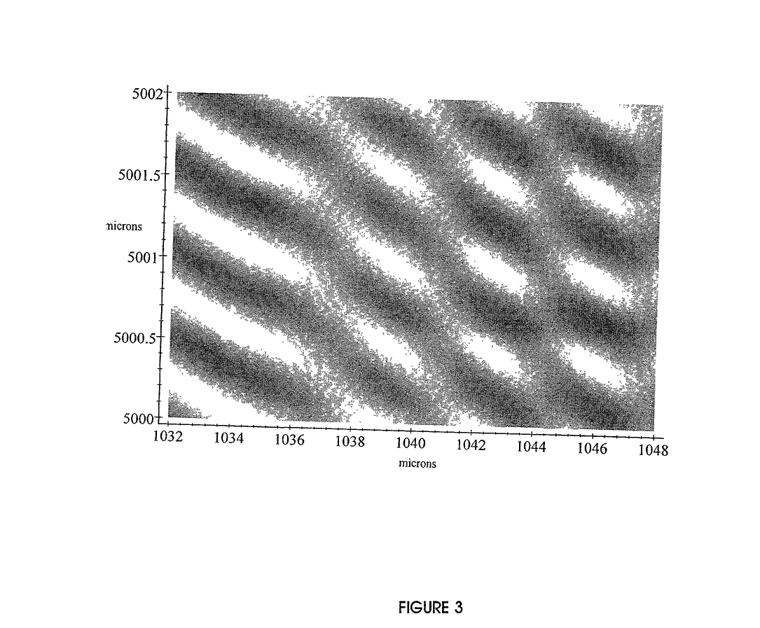

FIG. 3 provides an exemplary depiction of the generating function A(x,y). As shown in this figure, although each individual term in the sum forming the function A(x,y) corresponds to an elliptical sub-grating, no individual ellipses are evident in this figure because the summation results in overlaying multiple elliptical subgratings.

The generating function A(x,y) defines a rather complex two-dimensional relief with sub-micron features whose fabrication, for example, by utilizing lithographic techniques, is prohibitively difficult. Thus, in another step in a method for generating a photonic structure according to the teachings of the invention, the function A(x,y) is simplified by conversion into a binary function B(x,y) in accordance with the following relation:

B(x,y)=1, if A(x,y)>0 and Eq. (4)

B(x,y)=0 otherwise.

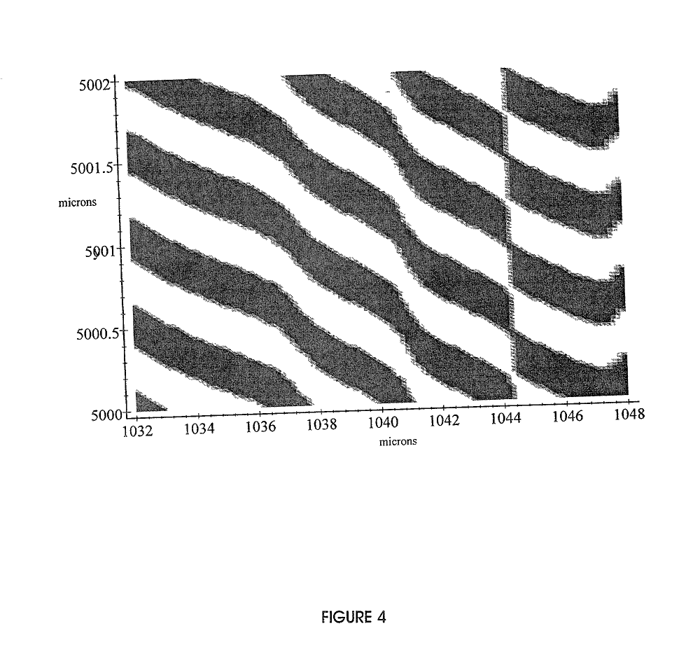

FIG. 4 depicts one example of the above function B(x,y), which resembles a warped chessboard.

The binary function B(x,y), though simplified relative to the function A(x,y), remains nonetheless typically too complex to be implemented as a relief on a planar surface. Thus, in preferred embodiments of the invention, the function B(x,y) is approximated by another function, herein referred to as C(x,y), as a plurality of discrete elements, for example, straight dashes of standard width or polygons. To maximize the reflections, it is preferable to select the width of a dash close to ¼ of the light wavelength propagating through the device. Also, the individual dashes should not touch each other. With these conditions observed, the two-dimensional relief described with the function B(x,y) is approximated with multiple individual dashes, locations and orientations of which are determined by the best fit to B(x,y). The best fit can be found by several standard methods, for example, the difference between B(x,y) and C(x,y) may be minimized by a least squares method.

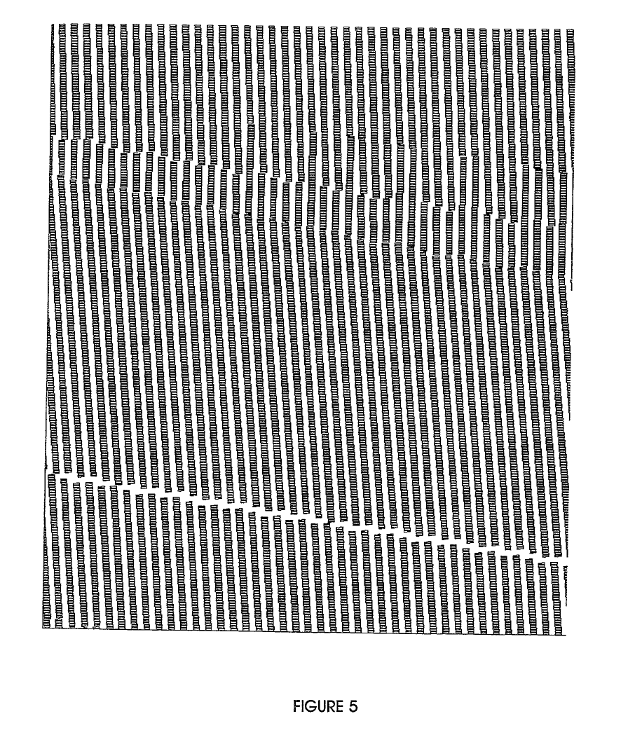

FIG. 5 provides an exemplary illustrations of a surface topography created by the function C(x,y). It should be noted that FIG. 5 is included simply for illustrative purposes. As seen in FIG. 5, C(x,y) represents a plurality of discrete elements (“dashes”) having selected widths, depths, and positions. The dashes defined by the function C(x,y) can be implemented as discrete micro-reflective elements to generate a photonic structure of the invention, as described below.

It is known that Bragg gratings can exhibit side lobes as a result of light reflection from front and back ends of the gratings, where large gradients of effective refraction indices can be created. This effect can be ameliorated by smoothing, e.g., apodizing, the front and the back ends of the gratings. In some embodiments of the invention, an apodizing function is utilized to smooth the variations of effective refractive index over a planar photonic structure generated in accordance with the teachings of the invention. For example, the following apodizing function in accord with the following relation can be utilized:

$$g ( r ) = {cos}^{2} \{ π [ \frac{( r - {r}_{0} )}{( d - {r}_{0} )} - \frac{1}{2} ] \} for {r}_{0} < r < {r}_{0} + d \\ g ( r ) = 0 otherwise , \qquad Eq . ( 5 )$$

where d is the supergrating length, r=r₀ and r=r₀+d correspond to the front and back ends of the supergrating, respectively. (See FIG. 2). The above function g(r) corresponds to zero modulation of the index of refraction everywhere other than in an area spanned by the photonic structure. Within the photonic structure, the above function g(r) varies smoothly from zero (no modulation) to unity (maximum modulation) at the center of the photonic structure, and then smoothly drops to zero at the back end of the structure. In other words, full modulation occurs at the center of the structure that is surrounded by areas in which modulation varies from zero to a maximum value or vice versa. The function g(r) can be incorporated in the above generating function A(x,y) by defining the above function ƒ(r) in terms of the function g(r) in accord with the relation:

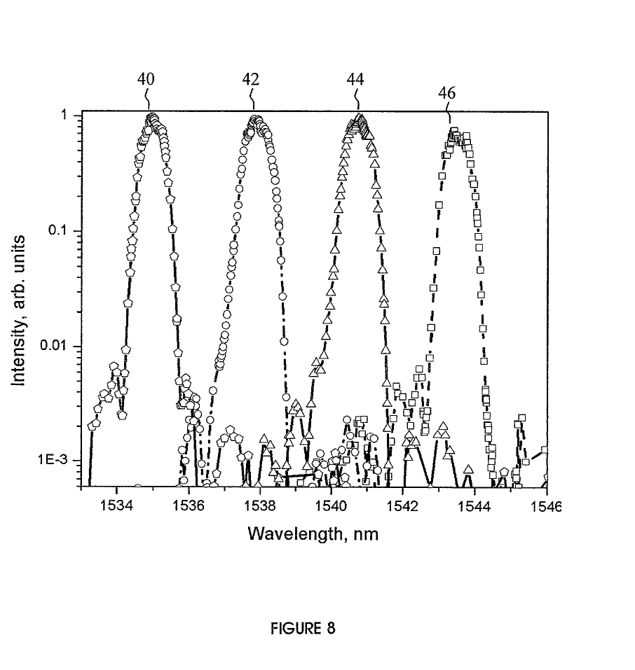

ƒ(r)=1+ag(r) Eq. (6).

wherein a is a selected constant. The constant a can be selected, for example, either experimentally or by simulation, to obtain an optimal fit between a transfer function associated with optical connections formed by the device and desired transfer function for those connections. For example, simulations were used to choose parameters for a proto-type optical device formed in accordance with the teachings of the invention for which experimental data are presented in FIG. 8.

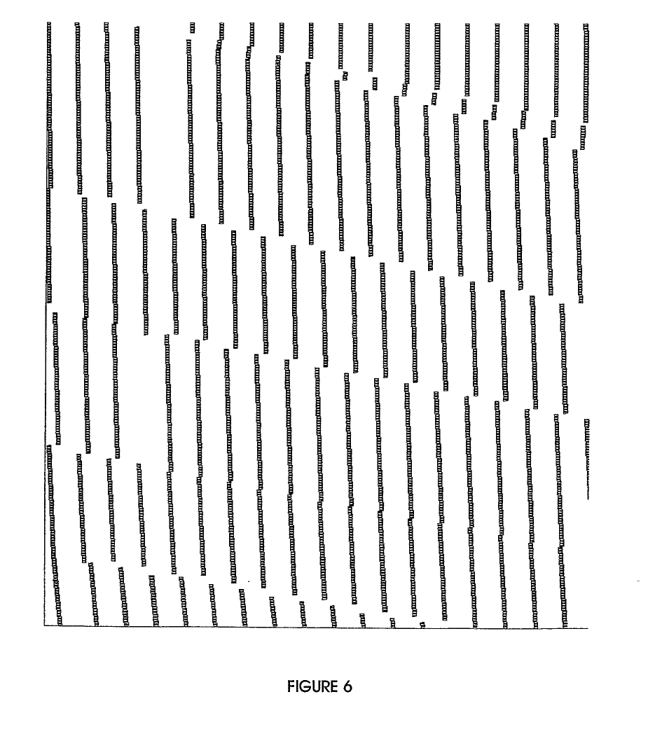

Further, the apodization of the mirco-reflective elements can be implemented by varying the density of these elements such that the average density of the elements varies in a continuous manner from the front end of the photonic structure to the back end of the structure. Preferably, the density of the microelements reaches a maximum at the center of the photonic structure and decays on both sides of the maximum in a smooth fashion. For example, the pattern of dashes shown in FIG. 5 can be apodized by selective removal of some of the dashes, as shown in FIG. 6.

Referring again to FIG. 2, the plurality of the discrete micro-reflective elements 20 can be generated, for example, in the form of grooves or ridges, on a planar surface of the waveguide 14, for example, on a top surface of the core layer 16, in accord with the pattern of discretized elements, e.g., dashes having predetermined widths, depth and position, provided by the above function C(x,y).

A variety of techniques known in the art can be utilized to generate the micro-reflective elements. These techniques modulate the effective refraction index of a waveguide, resulting in Fresnel reflection from boundaries between zones characterized by different values of refractive indices. Typically, this modulation is produced by variation of the thickness of one or more layers of the waveguide or by doping some waveguide zones to change their refractive index.

For example, direct e-beam writing can be employed to expose a photoresist layer on a planar surface to generate a pre-defined pattern of grooves or ridges, each of which corresponds to one of the above micro-elements. For example, a computer-aided-machining (CAM) system of an electron beam apparatus can be loaded with instructions corresponding to the locations of the micro-reflective elements corresponding to a discrete pattern generated in accord with the teachings of the invention, for example, the above function C(x,y). These instructions can then be employed to move the electron beam in a controlled manner over a substrate surface to generate the micro-reflective elements 22. Then, the photoresist can be developed and the surface etched.

Alternatively, photo-lithographic techniques can be employed to generate a pattern of discrete micro-elements in accord with the teachings of the invention. In addition, the discrete elements are not limited to grooves or ridges, but alternatively, they can correspond to micro-locations in which a selected dose of an ion is implanted in a substrate to cause a local variation of index of refraction. In fact, any technique that can generate a discrete pattern of refractive index variations in accord with the teachings of the invention, for example, in accord with the pattern provided by the above function C(x,y), can be employed to practice the invention.

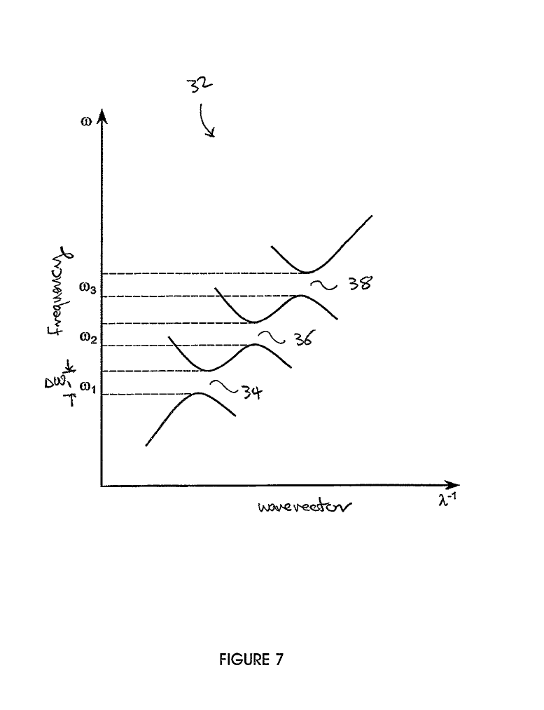

The selective directional response of a photonic structure of the invention as a function of wavelength of incident light, or more particularly, as a function of a plurality of passband regions in a wavelength range can be better understood by reference to an exemplary schematic dispersion diagram 32, shown in FIG. 7. It should be understood that the dispersion diagram 32 is provided only for illustrative purposes and does not necessarily accurately depict the actual dispersion characteristics of a photonic structure of the invention. Further, although the exemplary dispersion diagram 32 is one-dimensional, those having ordinary skill in the art will appreciate that an actual dispersion curve of a photonic structure of the invention can be three-dimensional in wave vector (λ⁻¹) space. The diagram 32 shows that a photonic structure of the invention can include a multiplicity of bandgaps, such as, exemplary bandgaps 34, 36, and 38. Each bandgap can effect the reflection of light within a frequency range corresponding to that bandgap. For example, the bandgap 34 is centered around a frequency ω₁ and spans a passband region Δω₁ whereas the bandgap 36 is centered around a different frequency ω₂ and spans another bandpass region Δω₂. Hence, the bandgap 34 effects reflection of light within the passband region Δω₁ whereas the bandgap 36 effects reflection of light within the passband region Δω₂.

As discussed above, as the wavelength of the light incident on the photonic structure varies within each passband region, for example, Δω₁, the direction of the output light generated by the photonic structure in response to the incident light remains fixed. That is, the photonic structure of the invention focuses light with any wavelength within a selected passband region to the same point.

Referring again to FIG. 2, the base 12 and the planar waveguide layer 14 of the exemplary optical device 10 of the invention can be formed of a variety of different materials. For example, in one embodiment, the base 12 can be formed of silicon, and the core 16 of the waveguide 14 can be formed, for example, of optical quality silicon, or silicon oxide (SiO₂), or SiON, or Si₃N₄. Further, the cladding layer 18 can be formed of SiO₂. In this embodiment, the core 16 can have a thickness in a range of about 0.01 microns to about 1 micron, and the cladding layer 18 should be thicker than 12 microns to prevent the leakage of light from the core to the substrate. Those having ordinary skill in the art will appreciate that materials other than those described above can be utilized to form an optical device of the invention. Further, the thickness of the substrate, the core and the cladding layers can be different than the exemplary values provided above to suit a particular application of the optical device 10. Further, an optical device of the invention can have an additional cladding layer disposed on the core layer 16, or can include multiple alternating layers of core and cladding.

It is well known that planar waveguides can support electromagnetic waves of two different polarizations, namely, TE-mode and TM-mode. Photonic multi-bandgap structures of the invention, and devices in which such photonic structures are incorporated, such as the optical device 10 (FIG. 2) can be designed to be utilized simultaneously with both TE and TM light polarizations while exhibiting negligible polarization dependent loss (PDL). For example, with reference to FIG. 2, the core 16 and the cladding 18 of the waveguide layer 14 can be formed of separate materials having significantly different refraction indices. For example, for the core 16 having an average index of refraction (n), the cladding can be selected to have an index of refraction in a range of about 0.5 n to about 0.8 n. Some suitable materials having significantly different refraction indices for formation of the core and the cladding can include, but are not limited to, silicon, silicon oxide (SiO₂), SiON, Si₃N₄, InP, Ta₂O₅. The significant difference in refraction indices of the core and the cladding results in significant difference in the effective refraction indices for the TE and TM polarizations. The difference in effective refraction indices of TE and TM modes should be sufficiently large to avoid reflection of TE modes due to gratings associated with TM modes and/or reflection of TM modes from gratings associated with TE modes. In particular, according to one embodiment, the following relationship is observed:

$$\frac{{γ}_{E} - {γ}_{m}}{{γ}_{E}} > 2 \frac{Δ f}{f}$$

where γ_{E} is the effective index of refraction for the TE mode and γ_{M} is the effective index of refraction of the TM mode.

Δf is the spectral range of a WDM system, and f is, e.g., central wavelength with the spectral range Δf.

If mutual transformation of TE and TM modes can be neglected, the above condition may be relaxed as follows:

$$\frac{{γ}_{E} - {γ}_{m}}{{γ}_{E}} > \frac{Δ f}{f}$$

This allows for writing separate subgratings for TE and TM polarizations of light. For example, if the difference in the effective refraction indices for the TE and TM polarizations is 5%, then the TM polarization will be additionally reflected from the TE sub-grating with 5% shift in frequency. This additional reflection will not degrade performance of the optical device because only about 2% bandwidth is typically used in modern lightwave communication. Thus, the additional reflection does not lie in the working bandwidth. Another problem is that TE and TM polarization reflection coefficients are typically different (the difference is about 5-20%). This problem can be resolved by 5-20% variations in the coefficients aᵢ in the above Equation (1) to compensate for the different reflection coefficients of the TE and TM polarizations. This approach is feasible because coefficients aᵢ lineary increase the reflectivity.

A photonic multi-bandgap structure can be created with binary micro-reflective elements by at least two different ways, by a simple superposition or synergetically. A simple superposition of many single-bandgap structures evidently creates photonic multi-bandgap structures. The drawbacks of the simple superposition are mutual interaction of the bandgaps, which can create undesirable reflections, and weak reflectivity because every micro-reflective element works for only one channel. A photonic multi-bandgap structure of the invention, herein also referred to as photonic bandpass quasi-crystal, exhibits a synergetic effect. That is, each micro-reflective element reflects light from a plurality of passband regions in different directions corresponding to different passbands, so that the reflections from other micro-reflective elements interfere constructively corresponding to these plurality of passband regions. In other words, before placing a micro-reflective element, the generating function A(x,y) polls all channels and then places the element to satisfy constructive interference for as many channels as possible. The element efficiency is proportional to the value of A(x,y) at the element position.

The synergetic property of a photonic structure of the invention provides a number of advantages relative to structures formed as simple superposition of rarified subgratings. In particular, the generating function A(x,y) has an average absolute value of approximately \sqrt{N}. In other words B(x,y) and, consequently, micro-reflective elements, create constructive interference for approximately \sqrt{N} connections, whereas in the case of a superposition of rarified subgratings, each connection works independently. As a consequence, for a synergetic photonic bandgap structure of the invention, and a superposition of rarified subgratings having the same number of optical connections N, and having the same number of etched microelements with the same depth and the same fraction of etched surface area (e.g., about 50%), the bandgap of the photonic structure of the invention (W_{syn}) is approximately \sqrt{N} wider than the bandgap of the superposition of rarified subgratings (Wₛᵤₚ). In other words, W_{syn}=\sqrt{N}Wₛᵤₚ.

An optical device of the invention, such as the exemplary optical device (FIG. 1), can be utilized in a variety of different applications. In one application, such an optical device can be employed as an optical multiplexer/demultiplexer. For example, with reference to FIG. 2, the optical device 10 can function as a demultiplexer in which the input port 20a receives light having a plurality of wavelength components, or more generally, a plurality of passband regions. The photonic structure 20 directs each wavelength component, or each passband region, to one of the output ports 20b-20m, thereby separating different wavelength components. Connections made by the quasi-crystal may be tailored for a specific device. For a demultiplexer, a low crosstalk can be achieved by applying apodization, and polarization dependent loss can be minimized by writing independent subgratings for TE and TM modes.

Alternatively, the optical device 10 of the invention can function as a multiplexer by utilizing the ports 20b-20m as input ports and the port 20a as an output port. In this case, each port 20b-20m receives light having a selected wavelength, or more generally, wavelength components within a selected passband region Δλ. The photonic structure 20 reflects the light received from each port 20b-20m to the port 20a. Cross talk does not pose a problem in a multiplexer. Thus, a multiplexer can be formed without a need for apodization. The absence of apodization makes effective reflection of subgrating larger, thus diminishing loss of light.

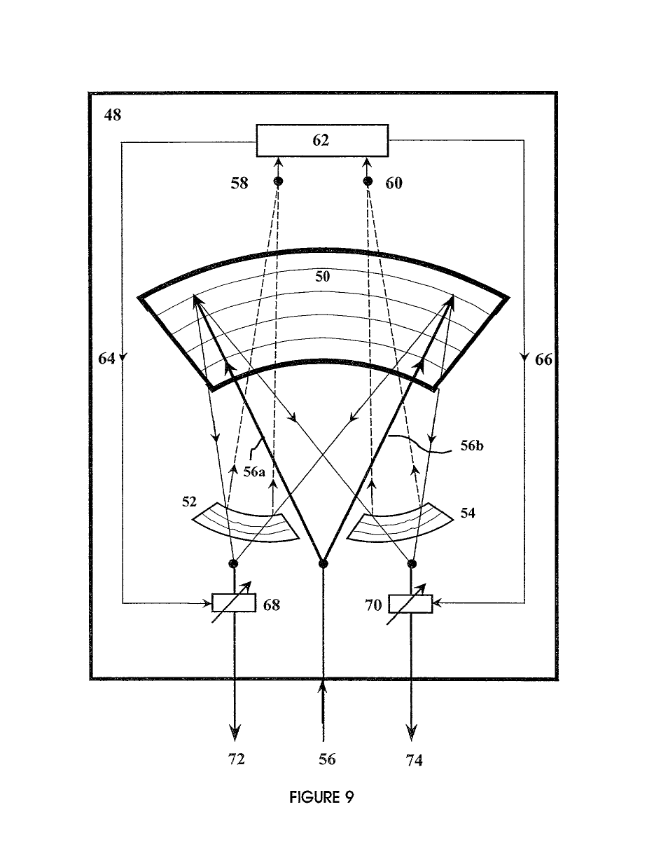

To illustrate the feasibility of manufacturing an optical device having a photonic multiband-gap structure according to the invention, FIG. 9 presents experimental data corresponding to a prototype optical device based on the exemplary device 10 (FIG. 2). This prototype demultiplexer includes an input port for receiving light having wavelengths spanning a range from about 1530 mn to about 1550 nm, and four output ports. The experimental data shows four signals 40, 42, 44, and 46, each of which is associated with one of the output channels. As evident in the figure, each output signal corresponds to a distinct passband region. As seen in the experimental data, this proto-type device exhibits some cross-talk between the channels. The cross-talk is suppressed relative to the signal level by a factor of approximately 28 dB. It should be understood that this experimental result is presented only to show the feasibility of constructing an optical device according to the invention, and is not intended to present optimal parameters, e.g., optimal suppression of cross-talk of a such a device.

As mentioned above, optical devices of the invention can find a variety of applications. Optical multiplexer/demultiplexers in accordance with the teachings of the invention can be employed, for example, in telecommunications systems that employ wavelength division multiplexing (WDM) for transmission of digital data. In such a system, an optical fiber carrying information in multiple communications channel, where each channel is associated with a particular wavelength range (passband region), can be coupled to the input port 20a. The photonic structure 20 separates the light corresponding to different channels such as the light for each channel is directed to one of the output ports.

Another possible application of the optical devices of the invention relates to devices for monitoring and dynamic control of the signals propagating in different channels of the multichannel systems. As shown in FIG. 9, one such exemplary device 48 combines an optical demultiplexer 50 formed in accordance with the teachings of the invention with two PBQC structures 52 and 54, which are also formed in accordance with the teachings of the invention, to monitor and control signals in a multi-channel system, as described below. In particular, the device 48 receives an input light signal 56 that illuminates the demulitplexer 50 with a plurality of light rays in a solid angle schematically depicted by two edge rays 56a and 56b.

The demultiplexer 50 selectively reflects one passband region towards the PBQC structure 52, and another passband region to the other PBQC structure 54. Each PBQC structure is designed so that a small fraction of the light signal at the corresponding wavelengths is selectively reflected and focused at the predetermined points, namely, points 58 and 60, in a planar area. At these points detectors, e.g., PIN detectors, can be installed to provide input signals for a dynamic control circuit 62. The output signals of the control circuit 62 are supplied to variable attenuators 68 and 70, installed in each channel, to receive light corresponding to that channel that is incident on either PBQC structure 52 or 54, and is transmitted through the respective PBQC structure onto one of the attenuators. The output signals provided by the control circuit 62 allows balancing the light power outputs 72 and 74 of the attenuators 68 and 70, respectively. It should be emphasized that the ability of the PBQC structures of the invention to focus the light beams of different wavelengths into any set of predetermined points over the planar area allows for considerable flexibility in the designing integrated optical circuits, such as the above channel monitoring and control device 48, since the beams may intersect each other when propagating within the planar waveguide.

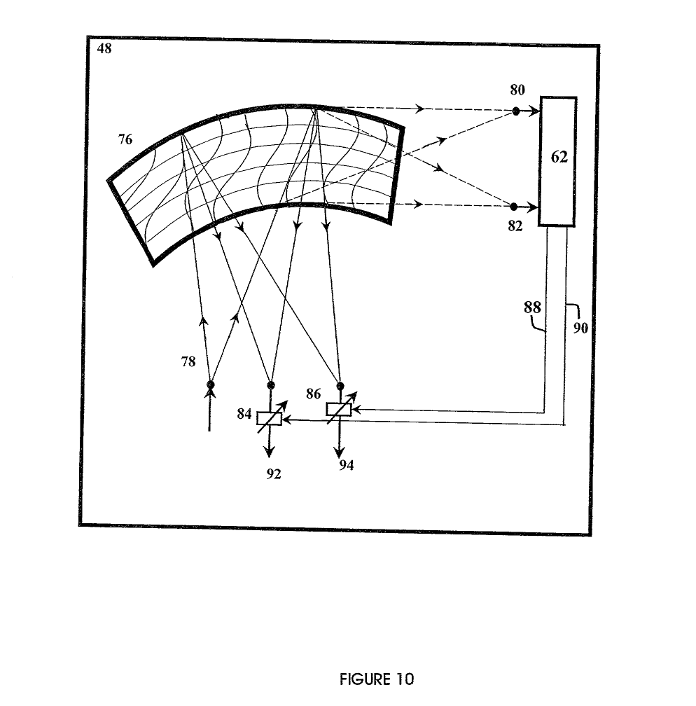

As shown in FIG. 10, the device presented in FIG. 9 can be modified by replacing the separate demultiplexer 50 and PBQC structures 52 and 54 with a single PBQC structure 76 that is designed in accordance with the teachings of the invention to reflect and focus a small portion of light corresponding to selected passband regioins encompassed within wavelength components of an incoming light signal 78 to points 80 and 82 at which PIN detectors are installed, and to reflect concurrently a larger portion of each of these passband regions to respective attenuators 84 and 86. As in the device of FIG. 9, the output signals of the PIN detectors are transmitted to the control unit 62 which in turn applies control signals 88 and 90 to attenuator 86 and 84, respectively, to set the attenuation level of each attenuator to obtain desired power levels for output signals 92 and 94. Channel monitoring requires reflection of approximately 10% of the power of an incoming signal, which can be achieved by applying small coefficients αᵢ for connections corresponding to the channel monitor. A flat top transfer function, desirable for a channel monitor, can be achieved by applying a chirped generating function.

Another application of photonic multi-band gap structures of the invention relate to multi-wavelength lasers that can be important elements of WDM systems. While multi-wavelength lasers can be realized with Fiber Bragg Gratings, the wavelengths of such lasers should be demultiplexed before modulation. Utilization of a PBQC-based demultiplexer according to teachings of the invention as an intra-cavity selective element makes it possible to realize simultaneously multiwavelength lasing and demultiplexing, which is of considerable interest for telecommunications purposes.

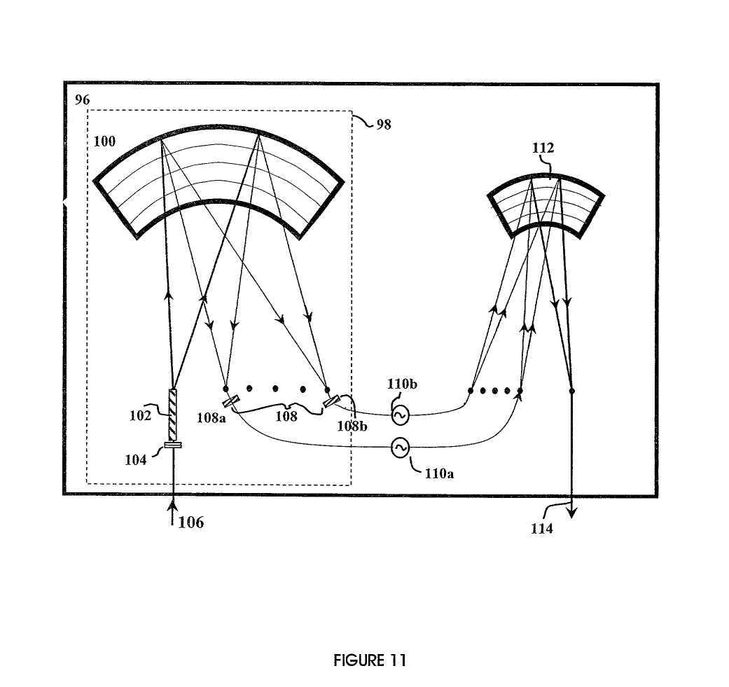

For example, FIG. 11 depicts a planar optical telecommunications system 96 having a multi-wavelength laser 98 in which a PBQC structure 100 according to the invention is incorporated to serve as a wavelength selective element for establishment of multiple lasing cavities for a plurality of wavelengths with a common active lasing medium 102 and a high-reflectivity broadband mirror 104 installed in the common focal point of the PBQC. A pump signal 106, for example, from another laser, pumps the lasing medium 102 in order to generate the requisite population inversion. A plurality of mirrors 108, such as mirrors 108a and 108b, each providing partial reflectivity, are positioned at the output focal points corresponding to the respective wavelength components. Thus, each mirror 106, together with the PBQX and the common lasing medium and the broadband mirror, provide a lasing cavity for a selected wavelength. Proper selection of mirror's reflectivity together with proper design of the PBQC structure make it possible to optimize the laser source performance.

Each mirror 108 allows a portion of the laser radiation corresponding to its respective wavelength to be outputted to a modulator, such as modulators 110a and 110b, that modulates the light corresponding to that wavelength. An optical multiplexer 112, formed in accordance with the teachings of the invention, combines light corresponding to different wavelength channels to provide a WDM signal 114 at the circuit output.

It should be mentioned that the additional measures may have to be taken for providing stable operation of such a system [N. J. C. Libatique and D. Huang, IEEE Photon. Technol. Lett. 11, 1584 (1999)], which is possible due to the fact that different wavelength channels outputted by the laser are spatially separated, thus allowing for additional power control according to the teaching of the previous example. Spatial separation of the channels is also advantageous because it allows the signal modulators to be installed in each channel immediately after the corresponding output ports, thus eliminating the need for an additional demultiplexer as it would be required in the case of multiwavelength sources utilizing fiber Bragg gratings.

The teachings of the invention, including the approach presented above for designing the above telecommunications systems, allow for optimal design of the MUX-DEMUX configurations while taking into account different requirements that need to be fulfilled in different parts of the circuit. For example, planar lasers generate linearly polarized light. Thus, a multiplexer can be designed for only one polarization. This can be achieved by setting to zero the coefficients αᵢ in the above formula (1) corresponding to another polarization. It should be also emphasized that the proposed approach opens ways for designing an entire telecommunications platform integrated on a single planar optical waveguide.

Those having ordinary skill in the art will appreciate that various modifications can be made to above embodiments without departing from the scope of the invention. The teachings of the various articles and other sources referenced herein are hereby incorporated by reference.

What is claimed is:

1. An optical device, comprising
an optical waveguide having at least one input port and a plurality of output ports, the waveguide being adapted for transmission of light having one or more passband regions (Δλ) within a selected wavelength range between said input and output ports,
a photonic multi-bandgap structure optically formed in said waveguide, wherein for each passband region (Δλ) within said selected wavelength range, the photonic structure directs light having wavelength components within said passband region from said input port to pre-selected output ports.

2. The optical device of claim 1, wherein the optical device includes a plurality of input ports and a plurality of output ports and said photonic structure directs light having wavelength components within said passband region from pre-selected input ports to pre-selected output ports.

3. The optical device of claim 1, the photonic multi-bandgap structure comprises a plurality of reflective micro-elements disposed on a planar surface of said waveguide so as to form a quasi-periodic pattern.

4. The optical device of claim 1, wherein each of said micro-elements provides a local modulation of index of refraction of said planar surface of the waveguide.

5. The optical device of claim 1, wherein said micro-elements reflect light having wavelength components within a plurality passband regions (Δλᵢ, i=1, . . . n) such that the reflections corresponding to each passband region Δλᵢ interfere on average constructively in a direction associated with selected ones of said output ports.

6. The optical device of claim 1, wherein the optical waveguide is planar.

7. The optical device of claim 6, wherein the micro-reflective elements are disposed on a surface (x,y) of said waveguide at locations corresponding substantially to local maxima of a two-dimensional generating A(x,y) representing a two-dimensional profile of refraction index as a linear superposition of a plurality of modulation functions each describing a separate sub-grating.

8. The optical device of claim 7, wherein said two dimensional generating function A(x,y) is defined in accord with the relation:
$$A ( x , y ) ∼ {\sum }_{i = 1}^{i = N} {a}_{i} Sin ( 2 π ( 1 + f ( x , y ) ) {l}_{i} / {λ}_{i} + {ϕ}_{i} ) ,$$
wherein the index i refers to a connection made between a selected input port and a selected output port,
$${l}_{i} = \vert {\vec{r}}_{i}^{i n} \vert + \vert {\vec{r}}_{i}^{out} \vert ,$$
wherein
$${\vec{r}}_{i}^{i n}$$
is a vector connecting the input port i to an arbitrary point (x,y) on the planar surface,
$${\vec{r}}_{i}^{out}$$
is a vector that connects this point (x,y) with the output port i for a chosen wavelength λᵢ, αᵢ is a weight coefficient associated with the connection i, and φᵢ is an arbitrary phase associated with the connection number i, and ƒ(x,y) is a function that compensates for variation of refractive index.

9. The optical device of claim 8, wherein the binary function B(x,y) is defined in accord with the relation:
B(x,y)=1, if A(x,y)>0 and
B(x,y)=0 otherwise.

10. The optical device of claim 9, wherein the micro-reflective elements are disposed on said surface in accord with a pattern defined by a function C(x,y) that approximates the function B(x,y) as a plurality of discrete elements having pre-defined shapes and positions.

11. The optical device of claim 10, wherein said discrete elements can be dashes having predefined widths, depths and lengths.

12. The optical device of claim 7, wherein said micro-reflective elements provide a quasi-periodic modulation of index of refraction of a surface of the waveguide.

13. The optical device of claim 10, wherein said micro-reflective elements comprise any of a groove, a ridge or a micro-location doped with a selected ion in a surface of said waveguide.

14. The optical device of claim 1, further comprising a substrate on which said optical waveguide is disposed as a stack of alternating low refractive index cladding and high refractive index core layers.

15. The optical device of claim 14, wherein said cladding layer has an index of refraction (n) and said core layer has an index of refraction in a range of about 1.2 n to about 2 n.

16. The optical device of claim 1, wherein said optical waveguide is substantially transparent to radiation having wavelength components in a range of about 800 nm to about 1600 nm.

17. The optical device of claim 16, wherein said optical waveguide is configured for transmission of light having any of a TM and TE polarization modes.

18. An optical device, comprising
a synergetic photonic light-guiding structure (herein referred to as photonic bandgap quasicrystal (“PBQC”) having a plurality of micro-reflective elements which generate on average constructive interference for a plurality of wavelengths of light incident thereon, said photonic structure having a plurality of bandgaps such that each band-gap effects reflection of light having one or more wavelength components within a selected wavelength range and incident on said structure in an input direction into a selected output direction forming a pre-defined angle relative to said input direction.

19. The optical device of claim 18, wherein said photonic structure comprises a planar layer and said micro-reflective elements of the photonic bandgap quasicrystal are disposed substantially on said layer in a quasi-periodic pattern and each providing a selected local modulation of index of refraction.

20. The optical device of claim 19, wherein said micro-elements reflect said incident light such that reflections of light from said plurality of elements interfere constructively in said output direction.

21. The optical device of claim 20, wherein said photonic structure comprises a planar layer and said micro-elements are disposed on said planar layer at locations corresponding substantially to local maxima of a two-dimensional generating function A(x,y) representing a two-dimensional profile of refraction index as a linear superposition of a plurality of modulation functions each describing a separate sub-grating.

22. The optical device of claim 21, said two dimensional function generating A(x,y) is defined in accord with the relation:
$$A ( x , y ) ∼ {\sum }_{i = 1}^{i = N} {a}_{i} Sin ( 2 π ( 1 + f ( x , y ) ) {l}_{i} / {λ}_{i} + {ϕ}_{i} ) ,$$
wherein the index i refers to a connection made between a selected input port and a selected output port,
$${l}_{i} = \vert {\vec{r}}_{i}^{i n} \vert + \vert {\vec{r}}_{i}^{out} \vert ,$$
wherein
$${\vec{r}}_{i}^{i n}$$
is a vector connecting the input port i to an arbitrary point (x,y) on the planar surface,
$${\vec{r}}_{i}^{out}$$
is a vector that connects this point (x,y) with the output port i for a chosen wavelength λᵢ, αᵢ is a weight coefficient associated with the connection i, and φᵢ is an arbitrary phase associated with the connection number i, and ƒ(x,y) compensates for variation of index of refraction across said photonic structure.

23. The optical device of claim 22, wherein the binary function B(x,y) is defined in accord with the relation:
B(x,y)=1, if A(x,y)>0 and
B(x,y)=0 otherwise.

24. The optical device of claim 23, wherein the micro-reflective elements are disposed on said surface in accord with a pattern defined by a function C(x,y) that approximates the function B(x,y) as a plurality of discrete elements having pre-defined shapes and positions.

25. The optical device of claim 24, wherein each of said micro-elements can be any of a groove, a ridge or a micro-location in which a selected ion is implanted.

26. The optical device of claim 22, further comprising one or more optoelectronic components integrated with said photonic structure in a single chip, wherein the coefficients aᵢ of the generating function A(x,y) determine transfer functions between components in optical communication via the photonic structure.

27. The optical device of claim 1, wherein said input port is adapted as an input port of an optical demultiplexer to receive light having wavelength components corresponding to a plurality of passband regions, and one or more of said output ports are adapted as output ports of said demultiplexer such that said photonic structure directs each bandpass region to one of said outports of the multiplexer.

28. The optical device of claim 2, wherein one or more of said output ports are configured as input ports of a multiplexer each receiving light having wavelength components within a seleced passband region, and at least one of said input ports is configured as an output port of said multiplexer such that said photonic structure directs light from each of said multiplexer input ports to said multiplexer output port.

29. An integrated multi-wavelength laser/optical modulator for use in a WDM system, comprising
a multi-wavelength laser formed in a planar waveguide, said laser comprising
a lasing medium adapted for emitting laser light having a plurality of wavelength components,
a broadband mirror optically coupled to said lasing medium,
a photonic multi-band gap structure optically coupled to said lasing medium to focus each wavelength component of light emitted from said lasing medium to one of a plurality of pre-defined locations in said waveguide, and
a plurality of mirrors each of which is positioned at proximity of one of said pre-defined locations corresponding to a wavelength component at which said each mirror is at least partially reflective, wherein each of said wavelength sensitive mirrors forms a lasing cavity with said photonic structure, said lasing medium, and said broadband mirror.

30. The integrated multi-wavelength laser/optical modulator of claim 29, wherein each of said wavelength sensitive mirrors allows transmission of a selected portion of light incident thereon having one or more wavelength components at which said mirror is partially reflective as an output signal.

31. The integrated multi-wavelength laser/optical modulator of claim 30, further comprising
a plurality of modulators formed in said waveguide, each modulator being optically coupled to one of said mirrors to receive and modulate an output signal corresponding a respective lasing cavity, and
a multiplexer having a photonic multi-bandgap structure receiving said modulated signals via a plurality of input ports, and directing said modulated signals to an output port.

32. A channel monitor and control device for use in a WDM system, comprising
a demultiplexer formed in a planar waveguide and having a photonic multi-band gap structure for directing each wavelength component of an input light signal to a pre-defined location in said waveguide,
a plurality of photonic multi-bandgap structures each being positioned at proximity of one of said pre-defined locations to receive a selected wavelength component of input light reflected by said demultiplexer, each of said photonic structure transmitting a portion of the received light and reflecting a smaller portion of the received light to a pre-defined location in said waveguide,
a plurality of detectors each positioned to detect light reflected from one of said photonic multi bandgap structures and to generate an output signal in response to said detected light,
a control circuit electrically coupled to said detectors to receive said electrical signals,
a plurality of attenuators electrical coupled to the control circuit, each attenuator being optically coupled to one of said photonic multi bandgap structures to receive the light transmitted thereby,
wherein the control circuit applies control signals to said attenuators in response to said received electrical signal to adjust attenuation levels of said attenuators.

33. A method of forming a light-guiding device, comprising
forming a planar waveguide having a plurality of input and output ports and being adapted for transmission of light having one or more wavelength components within a selected wavelength range between said input and output ports,
forming a qusi-periodic pattern of micro-reflective elements on a surface of said waveguide at locations corresponding substantially to local maxima of a two-dimensional function generating A(x,y) representing a two-dimensional profile of refraction index as a linear superposition of a plurality of modulation functions each defining a separate sub-grating

34. The method of claim 33, wherein the step of forming the quasi-periodic pattern further comprises defining the generating function A(x,y) in accord with the relation:
$$A ( x , y ) ∼ {\sum }_{i = 1}^{i = N} {a}_{i} Sin ( 2 π ( 1 + f ( x , y ) ) {l}_{i} / {λ}_{i} + {ϕ}_{i} ) ,$$
wherein the index i refers to a connection made between a selected input port and a selected output port,
$${l}_{i} = \vert {\vec{r}}_{i}^{in} \vert + \vert {\vec{r}}_{i}^{out} \vert ,$$
wherein
$${\vec{r}}_{i}^{in}$$
is a vector connecting the input port i to an arbitrary point (x,y) on the planar surface,
$${\vec{r}}_{i}^{out}$$
is a vector that connects this point (x,y) with the output port i for a chosen wavelength λᵢ, αᵢ is a weight coefficient associated with the connection i, and φᵢ is an arbitrary phase associated with the connection number i, and ƒ(x,y) is a function that compensates for variation of refractive index.

35. The method of claim 34, wherein the step of forming the quasi-periodic pattern further comprises defining the function B(x,y) in accord with the relation:
B(x,y)=1, if A(x,y)>0 and
B(x,y)=0 otherwise.

36. The method of claim 35, wherein the step of forming the quasi-periodic pattern further comprises disposing said micro-reflective elements on said surface in accord with a pattern defined by a function C(x,y) that approximates the function B(x,y) as a plurality of discrete elements having pre-defined shapes and positions.

37. The method of claim 36, further comprising selecting said discrete elements to be any of a groove, a ridge, or a micro-location doped with selected ions.

38. The method of claim 37, further comprising the step of utilizing lithography to form said discrete elements.

39. The method of claim 38, further comprising etching a surface of said waveguide by an ion beam to form said discrete elements.
